(19) United States
(12) Patent Application Publication
(10) Pub. No.: US 2006/0015371 A1
(43) Pub. Date: Jan. 19, 2006

(54) Health tracking system

(76) Inventors: Noah Knauf, Boston, MA (US); Iain Shovlin, Chicago, IL (US); Thomas Batten, Asheboro, NC (US); Zhonghui Xu, Lexington, MA (US)

Correspondence Address: ROBERT PLOTKIN, PC, 91 MAIN STREET, SUITE 204, CONCORD, MA, 01742-2527, US

(21) Appl. No.: 10/893,546

(22) Filed: Jul. 16, 2004

(51) Int. Cl. G06Q 10/00

(52) U.S. Cl. 705/3

(57) ABSTRACT

Techniques are disclosed for capturing first information (such as a digital photograph) descriptive of a health-related item (such as a meal or fitness device), and transmitting the first information to a server which queues the first information for subsequent association with second information (such as nutritional content information) descriptive of the health-related item. In one embodiment of the present invention, a user uses a cellular cameraphone to capture a digital photograph of a meal to be eaten, and transmits the digital photograph over a cellular telephone connection to a server, where the digital photograph is stored in the user's account. Additional information, such as a timestamp, may be generated automatically and transmitted for storage with the digital photograph. The user subsequently connects to the account and tags the digital photograph with nutritional information descriptive of the meal. Accurate and efficient tracking of the user's nutritional intake is thereby facilitated.

### BACKGROUND

1. Field of the Invention

The present invention relates to systems for tracking health-related activities performed by one or more individuals.

2. Related Art

People often desire to track the health-related activities in which they engage, such as the meals they eat and the exercises they perform. Individuals on a diet, for example, may seek to track the nutritional content of the meals they eat. Similarly, those striving to improve their fitness level may attempt to track the number of calories they burn daily through exercise. For such tracking to be effective, the individual needs to be able to record health-related information accurately, quickly, and easily.

For example, prior to the advent of computing technology, individuals who desired to track health-related information did so using written logs. A dieter, for example, may have written the contents of each meal in a notebook in chronological order, including information such as the names, quantities, and caloric content of the foods eaten. The same person might have kept a similar written record of his or her exercise activity, such as the time, distance, and duration of a daily run or bicycle ride, in a similar written log. Various companies continue to market logs containing pre-printed blank forms to facilitate the entry of such health-related information.

Although handwritten logs can be useful, they are prone to error and can be tedious and time-consuming to maintain. To keep complete records, the user of such a log must carry the log with him or her to each meal and to each fitness-related activity. If the user fails to bring the log to a particular activity, the user may not remember to enter the required information later, or may remember such information inaccurately, thereby decreasing the usefulness of the log. Furthermore, entering the required information (such as the names, quantities, and nutritional contents of foods in a meal) can be time-consuming, requiring the user to interrupt the activity to enter the required information. The need to spend a significant amount of time to perform data entry detracts from enjoyment of meals and other health-related activities, and may even discourage the user from using such logs at all.

Furthermore, the user may not remember or have access to all of the required information, such as the caloric content of a particular food. As a result, the user may be unable to enter all of the required information accurately, thereby decreasing usefulness of the log for tracking health-related information. In addition, a mere chronological record of health-related activities may not provide information to the user in a form that is useful for tracking health-related information over time. The user may, for example, need to manually tally daily caloric intake to determine whether the requirements of his diet are being met.

Various computer-based solutions have been developed in an attempt to solve at least some of the problems just described. For example, some special-purpose handheld electronic health logs perform functions similar to their paper-based counterparts, except that they allow health-related information to be entered and stored electronically. Such devices typically can calculate aggregate information, such as daily caloric intake, and provide reports and graphs to the user. Some such devices come equipped with a database of nutritional information for a fixed set of foods to eliminate the need for the user to memorize such information. Instead, the user who is about to eat a meal, for example, may identify the contents of the meal by selecting them from a list.

With the widespread adoption of personal computers (PCs) and personal digital assistants (PDAs), various software programs have been developed for enabling users to track health-related information. Some such programs behave similarly to the handheld electronic health logs just described. With the advent of the World Wide Web, various web sites have arisen which allow users to maintain their health logs online through web-based interfaces.

Such software and web sites, however, suffer from many of the same drawbacks as the first generation of paper-based health logs. For example, to input health-related information into PC-based software, the user must be physically present at the PC. To record information about a meal eaten at a restaurant or while traveling, or to record information about exercise performed outside of the home, the user must either attempt to remember such information or record such information manually (such as by writing it on a piece of paper) before transferring the information to the PC upon returning home. Such a process is tedious, time-consuming, and prone to error.

The quality of the output of health-tracking software (such as graphs of aggregate health statistics) depends on the quality of the input. Failure to enter health-related information completely and/or accurately reduces the effectiveness of such software for tracking health-related information over time. For example, if the user has been unable to provide complete and/or accurate nutritional data input to the software, the software will be unable to provide the user with accurate aggregate statistics (such as total caloric intake during a particular month). Therefore, it is critical that the user be provided with a fast and easy way to enter health-related information accurately.

Software which executes on a PDA or other mobile device improves on this situation by allowing the user to enter health-related information at the time health-related activities are performed. Such solutions, however, typically still require the user to engage in a significant amount of time-consuming data entry at the time of the health-related activity. For example, when eating a meal at a restaurant, the user may be required to enter information about each food item in the meal. Even if the health-tracking software provides lists of foods from which to select, it may be time-consuming for the user to identify and select each food item in his meal at the time of eating the meal, particularly given the small display screen and limited input devices with which PDAs typically are equipped. Furthermore, food databases typically are limited in scope and may not include the correct information, or any information, for the particular food items being eaten by the user. Such lengthy meal interruption to perform data entry decreases both enjoyment of the meal and accuracy of the health tracking services provided by the software, and may therefore discourage the user from purchasing or continuing to use the health-tracking software over time.

Even if the user is able to successfully enter meal-related or exercise-related information into a PDA, the small size and limited processing power of the PDA typically makes it poorly-suited for use to perform functions such as displaying graphs of caloric intake over time. As a result, the user must typically transfer data periodically from the PDA to a PC. This process of data synchronization can be time-consuming and may further discourage the user from using the health-tracking software on a regular basis.

In summary, an increasing number of people are interested in performing nutritional tracking and other forms of health-related tracking. Current technologies for performing such tracking, however, involve time-consuming and error-prone data-capture schemes which disrupt the users' routines and therefore limit both the effectiveness of such technologies for health tracking and the number of individuals willing to use such technologies. What is needed, therefore, are improved techniques for capturing data from users for use in nutritional tracking and other forms of health-related tracking.

### SUMMARY

Techniques are disclosed for capturing first information (such as a digital photograph) descriptive of a health-related item (such as a meal or fitness device), and transmitting the first information to a server which queues the first information for subsequent association with second information (such as nutritional content information) descriptive of the health-related item. In one embodiment of the present invention, a user uses a cellular cameraphone to capture a digital photograph of a meal to be eaten, and transmits the digital photograph over a cellular telephone connection to a server, where the digital photograph is stored in the user's account. Additional information, such as a timestamp, may be generated automatically and transmitted for storage with the digital photograph. The user subsequently connects to the account and tags the digital photograph with nutritional information descriptive of the meal. Accurate and efficient tracking of the user's nutritional intake is thereby facilitated.

For example, in one aspect of the present invention, techniques are disclosed for: (A) receiving, from a user, first information descriptive of a health-related item in the presence of a user of the item; and (B) queuing the first information for subsequent association with second information descriptive of the health-related item. The health-related item may, for example, be a meal to be consumed by the user or a fitness device to be used by the user. The first information may, for example, include information derived automatically from the health-related item, such as an digital photograph of the health-related item and/or information descriptive of nutritional content of the health-related item. The first information may, for example, include information derived from a context of the health-related item, such as a time at which the information captured automatically was captured, and/or a location of the health-related item. The user may transmit the second information, which may, for example, include information descriptive of nutritional content of the health-related item.

In another aspect of the present invention, techniques are disclosed for: (A) capturing first information descriptive of a health-related item in the presence of a user of the item; and (B) transmitting the first information to a system for subsequent association with second information descriptive of the health-related item. The health-related item may, for example, be a meal to be consumed by the user or a fitness device to be used by the user. The first information may, for example, include information derived automatically from the health-related item, such as an digital photograph of the health-related item and/or information descriptive of nutritional content of the health-related item. The first information may, for example, include information derived from a context of the health-related item, such as a time at which the information captured automatically was captured, and/or a location of the health-related item. The user may transmit the second information, which may, for example, include information descriptive of nutritional content of the health-related item.

Other features and advantages of various aspects and embodiments of the present invention will become apparent from the following description and from the claims.

### BRIEF DESCRIPTION OF THE DRAWINGS

FIG. 1A is a dataflow diagram of a system for capturing data to be used for nutritional tracking according to one embodiment of the present invention;

FIG. 1B is a dataflow diagram of a system for associating additional health-related information with a health-related item according to one embodiment of the present invention;

FIG. 1C is a block diagram illustrating health-related information stored in a user account according to one embodiment of the present invention;

FIG. 2A is a flowchart of a method that is performed by the system of FIG. 1A according to one embodiment of the present invention;

FIG. 2B is a flowchart of a method that is performed by the system of FIG. 1B according to one embodiment of the present invention;

FIG. 3 is a flowchart of a method that is performed in one embodiment of the present invention to process incoming streams of health-related data according to one embodiment of the present invention;

FIG. 4A is a flowchart of a method that is performed by a capture server in one embodiment of the present invention to filter certain incoming messages from being stored in user accounts according to one embodiment of the present invention;

FIG. 4B is a flowchart of a method that is performed by a capture server in one embodiment of the present invention to process non-standard messages; and

FIG. 5 is a flowchart of a method that is performed by a capture server to convert health-related information from one format to another according to one embodiment of the present invention.

### DETAILED DESCRIPTION

Techniques are disclosed for capturing first
information (such as a digital photograph) descriptive of a health-related item (such as a meal or fitness device), and transmitting the first information to a server which queues the first information for subsequent association with second information (such as nutritional content information) descriptive of the health-related item. In one embodiment of the present invention, a user uses a cellular cameraphone to capture a digital photograph of a meal to be eaten, and transmits the digital photograph over a cellular telephone connection to a server, where the digital photograph is stored in the user's account. Additional information, such as a timestamp, may be generated automatically and transmitted for storage with the digital photograph. The user subsequently connects to the account and tags the digital photograph with nutritional information descriptive of the meal. Accurate and efficient tracking of the user's nutritional intake is thereby facilitated.

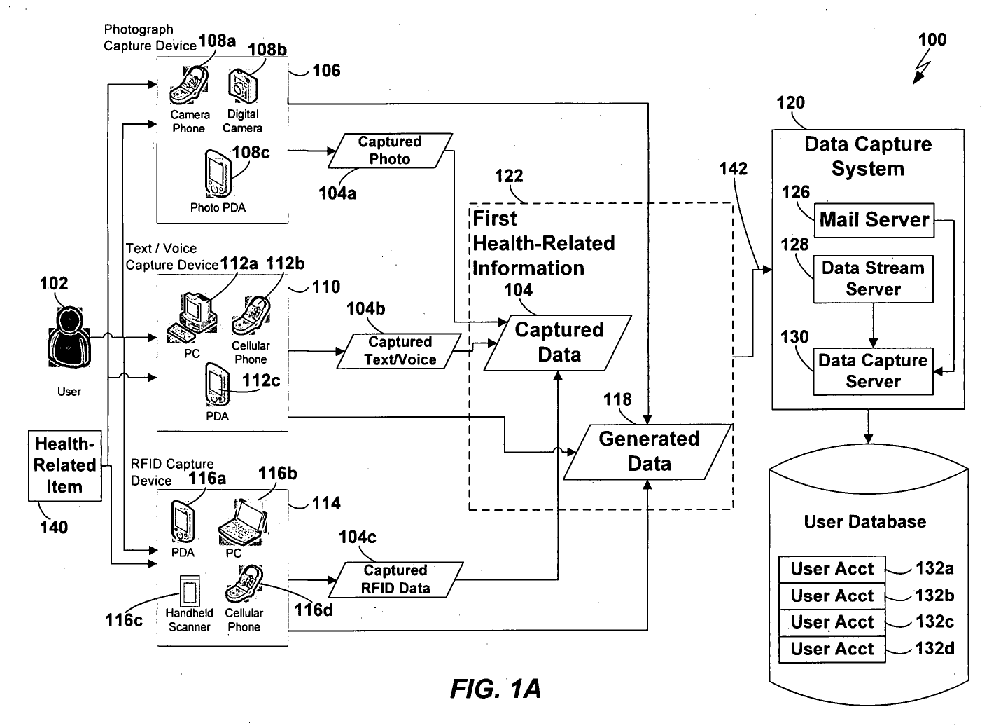

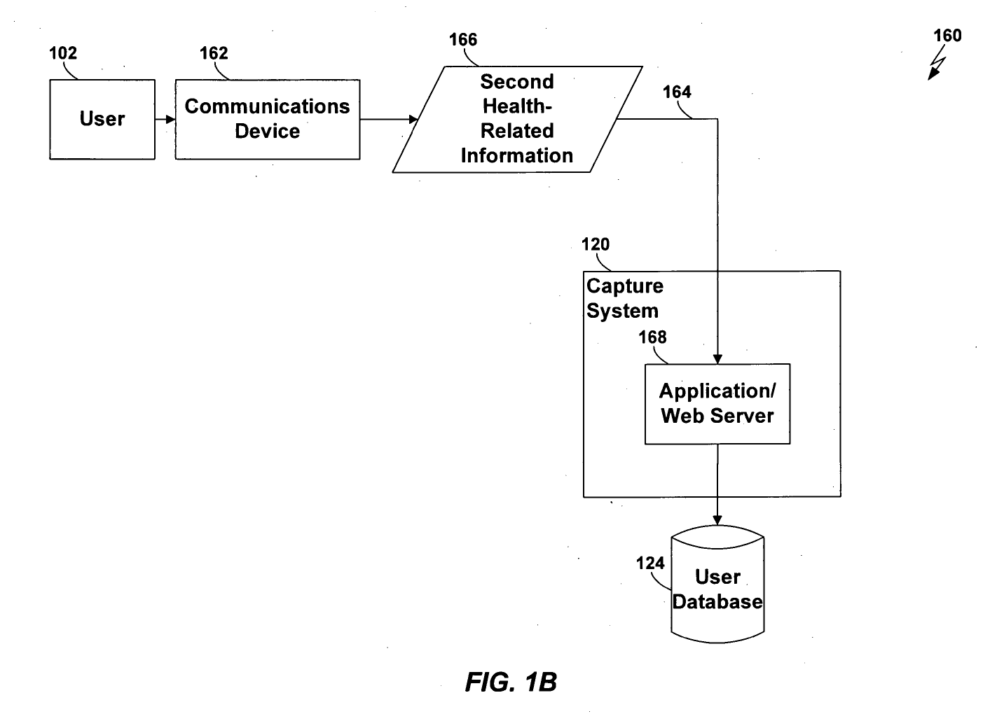

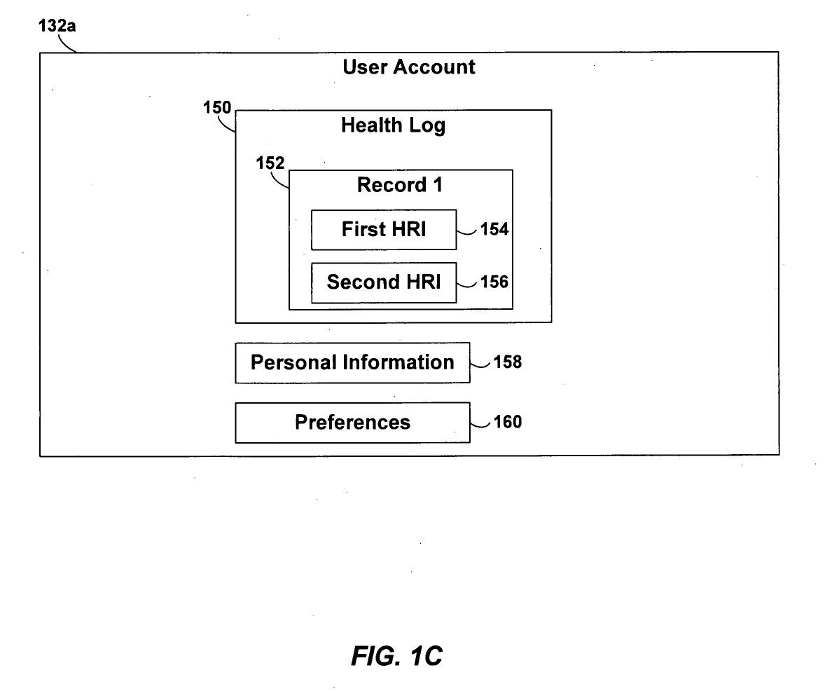

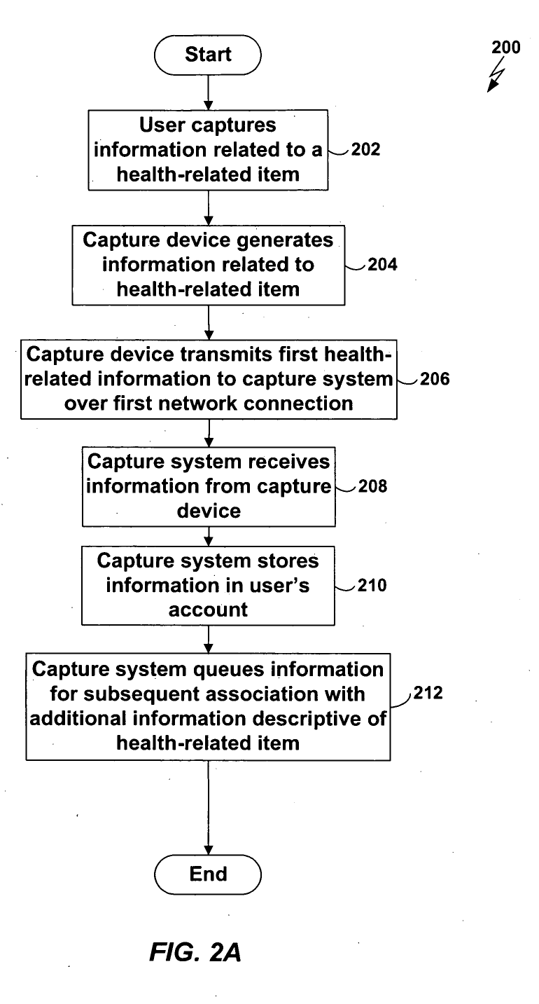

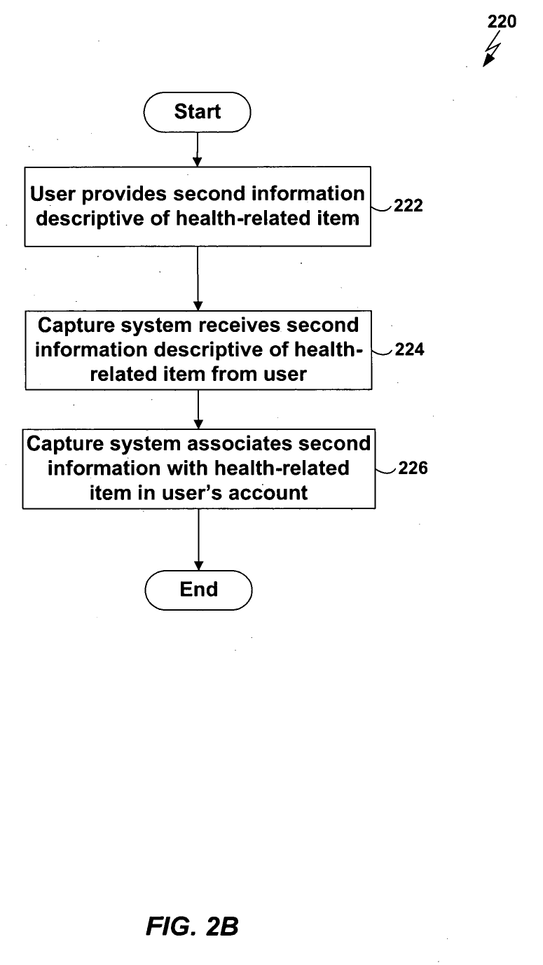

Referring to FIG. 1A, a dataflow diagram is shown of a system 100 for capturing data to be used for tracking health-related information, such as nutritional information, according to one embodiment of the present invention. Referring to FIG. 2A, a flowchart is shown of a method 200 that is performed by the system 100 according to one embodiment of the present invention.

A user 102 desires to track health-related information, such as information related to his or her diet and/or fitness activities. For example, the user 102 may desire to track his or her nutritional intake over time. The user 102 uses a capture device to capture information 104 related to a health-related item 140 that is in the presence of the user 102 (step 202).

The captured information 104 may be captured using any kind of capture device. Examples of such capture devices include, but are not limited to, photograph capture devices 106 (such as a camera phone 108a, digital camera 108b, and photo PDA 108c) for capturing digital photographic information 104a, text/voice capture devices 110 (such as a desktop or laptop personal computer 112a, cellular telephone 112b, and PDA 112c) for capturing text/voice information 104b, and RFID capture devices 114 (such as a PDA 116a, PC 116b, handheld scanner 116c, and cellular telephone 116d) for capturing RFID data 104c. The photographic information 104a, text/voice information 104b, and RFID data 104c are all examples of “captured information” 104 as that term is used herein. The particular examples of devices 106, 110, and 114 shown in FIG. 1A are provided merely for purposes of example and do not constitute limitations of the present invention.

Consider an example in which the health-related item 140 is a meal. The user 102 may, for example, use any of the photograph capture devices 106 to capture a digital photograph of the meal before consuming the meal, thereby generating the photographic information 104a in the form of a digital photograph of the meal. Similarly, the user 102 may, for example, use any of the text/voice capture devices 110 to generate a textual description of the meal (such as by writing notes describing the contents of the meal) and/or to generate a spoken audio description of the meal (such as by speaking a description of the meal into a microphone in the text/voice capture device 110), thereby generating the text/voice information 104. The text/voice message 104b may include, for example, a description of the health-related item 140 (such as the name of the item 140, the nutritional contents of a meal, or the duration of a fitness activity), or the user's weight or other characteristics.

Similarly, the user 102 may, for example, use any of the RFID capture devices 114 to scan an RFID tag associated with the meal, such as an RFID tag attached to the meal and/or the meal's packaging, thereby generating the RFID data 104c. Remote Frequency Identification (RFID) is a general term used to describe the identification of objects using passive or active radio devices attached to such objects. An RFID tag may include any kind of digitized health information about the health-related item 140, such as its unique identifier (SKU), calories, fat and other nutrients, food allergy alerts, and vitamins. To use such one of the RFID capture devices 114, the user 102 may pass the device over the RFID tag. In response, the RFID capture device 114 may identify the presence of the RFID tag, decode the RFID data based on one of many industry data standards, convert that data to one of many interchangeable formats (i.e. XML, CSV, etc), and connect to a network or other device to transmit the data.

The health-related item 140 for which information is captured in step 202 need not be a meal. Rather, the health-related item may be any item related to the health of the user 102. The term “health” is used broadly herein to refer to the health, wellness, and/or fitness of the user 102. The health-related item 140 may, for example, be a meal, snack, or beverage; a fitness device (such as treadmill, weight machine, or weight scale) or other item associated with a fitness-related activity (such as a jogging trail, stopwatch, sports field, or the user 102 engaged in a workout); vital statistics such as blood pressure, blood sugar, or body measurements; or any other item reminding the user 102 of a particular health-related activity.

Furthermore, the first health-related information 122 may include both data that is captured by one or more of the capture devices 106, 110, and 114, and data that is provided by the user 102 using one or more of the capture devices 106, 110, and 114, and/or using another device. For example, the user 102 may capture a digital photograph of the health-related item 140 using the camera phone 108a and dictate a partial description of the health-related item 140 using the camera phone 108a. In such a case, the first health-related information 122 may include both the captured photograph and a digital recording of the user's description of the health-related item 140.

The capture device may optionally generate additional information 118 related to the health-related item 140 (step 204). The additional information 118 may, for example, be generated based on the context of the health-related item rather than captured from the health-related item 140 or the user 102. For example, the capture device may use an internal clock to generate a timestamp indicating the date and/or time at which the captured information 104 was captured. Similarly, the capture device may use an internal global-positioning system (GPS) receiver to generate a location stamp indicating the location of the health-related item 140 at the time the captured information 104 was captured. Note that the generated information 118 may not need to be generated and stored independently of the creation and storage of the captured data 104. For example, the capture device may by default create a timestamp in the form of a creation date/time that is recorded in the same file as the captured data 104. In such a case, the creation date/time within the captured data 104 may perform the same function as the generated data 118.

After generating the captured data 104 (and any desired generated data 118), the user 102 instructs the capture device to transmit the captured information 104 (and optionally the generated information 118) to a data capture system 120 over a first network connection 142 (step 206). The combination of the captured data 104 and any additional generated data 118 will be referred to herein as “first health-related information” 122. The user 102 may instruct the capture device to transmit the first health-related information to the capture system 120 in any of a variety of ways, such as by pressing a “transmit” button on the capture device or issuing an appropriate command using a software program executing on the capture device.

The first network connection 142 may be any kind of network connection, and the first health-related information 122 may be transmitted over the first network connection 142 using any kind of network protocol. For example, if the camera phone 108a is used as the capture device, the first network connection 142 may be a cellular telephone network connection. The capture device may be configured with the telephone number, network address, or other identifier of the capture system 120, thereby enabling the capture device to establish the first network connection 142 with the capture system 120. For example, the capture device may be equipped with a software program that is configured with the network address of the capture system 120. When the user 102 issues a “transmit” command to the capture device, the capture device may use the network address to automatically establish the first network connection 142 and then transmit the first health-related information 122 to the capture system 120.

The data capture system 120 may include one or more communications servers, such as a mail server 126 and a data stream server 128, for receiving the first health-related information 122 over the first network connection 142 (step 208). For example, if the first health-related information 122 is transmitted in an email message, the first health-related information 122 may be received by the mail server 126. If the first health-related information 122 is transmitted as a data stream, the first health-related information 122 may be received by the data stream server 128. Note that the particular communications server 126 and 128 shown in FIG. 1A are merely examples and do not constitute limitations of the present invention.

The data capture system 120 also includes a data capture server 130 to act as a server of health-related information for the user 102 and (optionally) for other users (not shown). After the first health-related information 122 is received by one of the communications servers 126 and 128, the first health-related information 122 may be transmitted to the data capture server 130. The data capture server 130 may maintain a user database 124 which stores accounts 132a-d for the user 102 and for other users. Assume for purposes of the following discussion that account 132a is the account for user 102, while accounts 132b-d are accounts for other users of the system 120. Although only four accounts 132a-d are shown in FIG. 1A for ease of illustration, the database 124 may include any number of accounts.

The user database 124 may store any kind of health-related information for the users of the system 120. For example, referring to FIG. 1C, a block diagram is shown illustrating information stored in the user account 132a for user 102 according to one embodiment of the present invention. The health-related account 132a includes a log 150 of health-related activities performed by the user 102, such as the meals consumed by the user 102 and/or the exercises performed by the user 102. The user's account 132a may also include information 158 personally identifying the user 102, such as the user's name, height, weight, target weight, desired diet, username, password, and billing information. The user's account 132a may also include the user's preferences 160, such as whether the user 102 prefers to be contacted by email, telephone, or SMS message.

After receiving the first health-related information 122 from the user 102 (step 208), the capture system 120 stores the information 122 in the user's account (step 210) and queues the information for subsequent association with additional information descriptive of the health-related item 140 (step 212). Such additional health-related information will be described in more detail below. For example, referring to FIG. 1C, the user's health log 150 is shown to include a single record 152. The record 152 includes both first health-related information (“first HRI”) 154 and second HRI 156. After receiving the first HRI 142 from the user 102, the first HRI 142 may be stored in the first HRI field(s) 154 of the record 152. At this point, the second HRI field(s) 156 would be empty. Note that although only a single record 152 is shown in FIG. 1C, additional records may be added to the log 150 as the user 102 provides additional health-related information to the system 120.

In general, the capture system 120 serves as the central location to which all health-related data streams arrive and are processed. As data arrive, the system 120 extracts relevant data attributes, converts the media to a standard system format, and stores the information in the appropriate user account for future review by the user 102.

Once the first health-related information 122 has been stored in the user's account 132a, the user 102 may subsequently provide to the system 120 additional information related to the health-related item 140. The server 120 may associate such additional information with the record for the health-related item 140 in the user's account 132a in the database 124. For example, the additional information received from the user 102 may be stored in the second HRI field 156 of the record 152, thereby associating the additional information with the original information stored in the first HRI field 154.

For example, the user 102 may provide the first health-related information 122 while eating a meal, such as by capturing a digital photograph of the meal, and transmitting the digital photograph over the first network connection 142 to the capture system 120. Such capture and transmission may be performed relatively quickly, requiring only a few seconds of the user's time. The user 102 may then engage in the health-related activity, such as eating the meal, without further interruption.

Referring to FIG. 1B, a dataflow diagram is shown of a system 160 for associating additional health-related information, referred to herein as “second health-related information,” with the health-related item 140 according to one embodiment of the present invention. Referring to FIG. 2B, a flowchart is shown of a method 220 that is performed by the system 160 according to one embodiment of the present invention.

The user 102 provides the second health-related information 166 to the capture system 120 (step 222). Any amount of time may pass between the time when the user 102 provides the first health-related information 122 (FIG. 2A, step 206) and the time when the user 102 provides the second health-related information 166. For example, assume that the health-related item 140 is a meal eaten at a restaurant. Upon returning home from the restaurant, the user 102 may use a communications device 162 (such as a home PC) to access the Internet and log on to her user account 132a using a web-based interface provided by an application/web server 168 in the capture system 120. The user 102 may view the contents of the database record 152 for the health-related item 140. For example, the user 102 may view the digital photograph that was taken at the restaurant. The user 102 may then provide additional information about the health-related item 140, such as identifying the specific food items and their associated nutritive content in the meal, over a second network connection 164. Upon receiving the additional health-related information 166, the application/web server 168 may associate the second information 166 with the health-related item 140 (step 226). For example, the server 168 may store the second information 166 in the second HRI field 156 of the record 152 for the health-related item 140. As a result, the record 152 may include both the first health-related information 122 originally provided by the user 102 (such as a digital photograph of a meal) and the second health-related information 166 subsequently provided by the user 102 (such as information about the nutritional content of the meal).

The captured information 104 and generated information 118 may be transmitted to the capture system 120 using any of a variety of protocols and via any of a variety of network connections. For example, the text data 104b may be transmitted in the form of an email message, SMS text message or other cell phone text service, web-based (HTTP) message, or any other means of transmitting text across a network. Such information may, for example, be transmitted as voice data 104b by attaching a recording to an email, calling into a voicemail system, uploading the contents of a voice recorder, using “push-to-talk” transmission directly to the system 120, or any other means of transmitting voice messages across a network.

The capture device may be equipped with a software program (such as a standalone application program or browser plugin) which is configured with the network address of the data capture system 120 and the user's account information (such as the user's username and password). The user 102 may use such a software program to transmit the first health-related information 122 to the data capture system 120, in which case the software program may automatically log in to the user's account using the stored account information. As a result, the user 102 may cause the first health-related information 122 to be transmitted, stored, and queued in the user's account 132a with the press of a single button, or with some other simple action(s). Alternatively, the user 102 may be required to input certain information, such as his username and/or password, each time health-related information is transmitted by the capture device to the capture system 120.

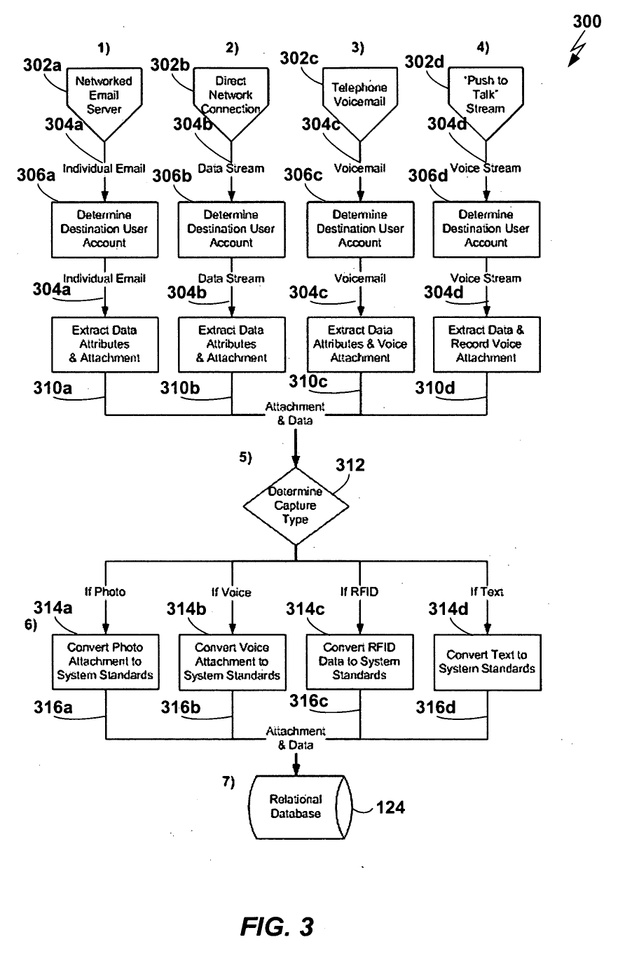

It was stated generally above with respect to steps 208-210 that the capture system 120 may receive and store the first health-related information 122 from the user 102. Techniques for performing such reception and storage will now be described in more detail. Referring to FIG. 3, a flowchart is shown of a method 300 that is performed by the capture system 120 in one embodiment of the present invention to process incoming data streams from the capture devices 106, 110, and 114. The capture devices may transmit the first health-related information 122 in any of a variety of forms, such as an email message (with or without attachments), a data stream transmitted over a direct network connection, a telephone voicemail message, or a “push to talk” cellular telephone stream.

Any variety of the first health-related information 122 may be transmitted to the capture system 120 in the form of an attachment to an email message. For example, most network-enabled camera devices have the ability send a photo to another individual by attaching or embedding the photo to an email message. The user 102 may be assigned a unique email address that is the destination for their captured health-related data. The data capture system 120 may include a standard incoming (e.g., POP) mail server 302a. As email messages arrive from users, the mail server 302a may queue the email messages for processing by the capture system 120, as described above with respect to FIG. 2A.

A standard network-enabled voicemail system 302c may be attached to the capture system 120. Users may call into the voicemail system 302c from any telephone connection, and leave a message containing health-related information in their personal voicemail account. The voicemail system 302c may then queue the voicemail messages for processing by the capture system 120, as described in more detail above with respect to FIG. 2A.

Cell phone carriers are increasingly offering a “push-to-talk.” functionality to customers. Businesses with field operations employ a dispatch system for centralized communication with many “push-to-talk” devices. Such a system 302d may be attached to the capture system 120 to facilitate real-time capture from users with “push-to-talk” cell phones.

The first and second health-related information 122 and 166 may be transmitted over any of a variety of network connections, such as a wired Ethernet connection, wireless data connection (e.g., 802.11x or Bluetooth), or cellular telephone network connection. Note that the first network connection 142 and the second network connection 164 may be different connections. Furthermore, they may be different kinds of connections. For example, the first network connection 142 may be a cellular telephone network connection established by the camera phone 108a, while the second network connection 164 may be a wired Ethernet connection established by the user's home PC. The first and second network connections may, however, be the same kind of connection. Furthermore, the user 102 may use a single device (such as the camera phone 108a) to transmit both the first health-related information 122 and the second health-related information 166. Alternatively, the user 102 may use different devices to transmit the first and second health-related information 122 and 166. For example, the user 102 may use the camera phone 108a to transmit the first health-related information, but use a home PC to transmit the second health-related information 166. Furthermore, either or both of the first and second network connections may include a series of connections. For example, the first network connection 142 may include a Bluetooth connection followed by a WiFi (e.g., 802.11g) connection.

Furthermore, the first and second health-related information 122 and 166 may be transmitted to the capture system 120 using any kind of network protocol. The user 102 may, for example, use protocols including HTTP or TCP-IP to upload data to the system 120. As devices capable of direct communication emerge in the marketplace, the system 120 may provide direct APIs to receive photo, voice message, or RFID attachments and the associated data. The capture system 120 may process such data using the same methodology described herein with respect to email messages.

Consider first an example in which the first health-related information 122 is transmitted to the capture system 120 in the form of an email message 304a. The capture system 120 may include a networked email server 302a (such as the server 126 shown in FIG. 1A). The email server 302a may process email messages in a first in, first out (FIFO) order. For each email message 304a that is processed, the capture server 120 determines the destination user account (step 306a) by examining the “To:” field of the email message 304a. Each user account may be associated with a corresponding unique email address. For example, if the user account 132a has the username JohnDoe, the account 132a may have the email address JohnDoe@nutrax.com. The capture system 120 may therefore identify the destination user account in step 306a by extracting the username from the “To:” field of the incoming email message 304a.

The capture system 120 may be configured to extract any combination of data fields and/or attachments 310a from the email message 304a (step 308a). Using the API to a standard email server, the capture server 120 may, for example, extract the email alias, time, date, text, and subject of the email message 304a. Additionally, attachments and information such as geographic coordinates and other meta-data may be extracted if contained within the email message 304a.

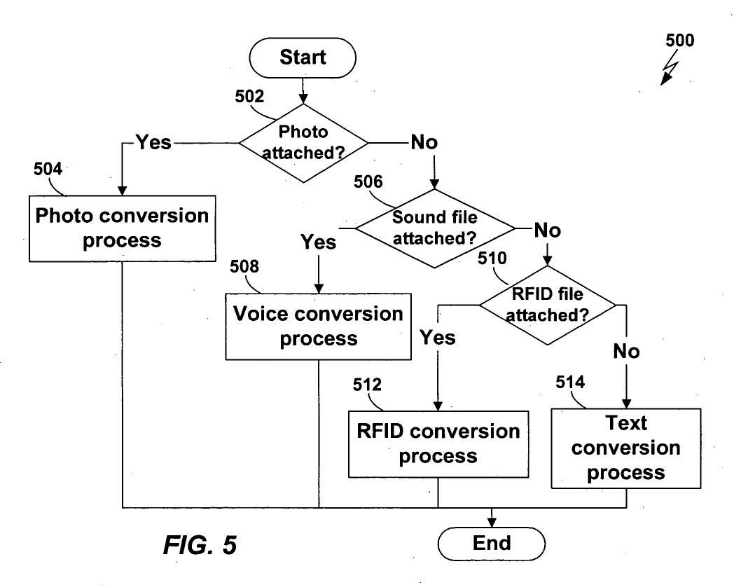

The capture server 120 determines the media type of the extracted attachment and/or data 310a (step 312). In one embodiment of the present invention, the capture server 120 determines the media type of the extracted attachment 310a based on the file extension of the attachment 310a. Referring to FIG. 5, a flowchart is shown of a method 500 that is performed by the capture server 120 to perform an appropriate conversion process based on the identified media type according to one embodiment of the present invention.

Attachments may arrive to the system 120 in a variety of formats and resolutions. As will now be described in more detail, incoming attachments and data may be converted to a common format with consistent resolutions, bit rates, and other measures of quality. For example, in the method 500 illustrated in FIG. 5, the capture server 120 determines whether the attachment 310a contains a photo (step 502), such as by determining whether the extension of the attachment 310a matches a table of administrator-defined standard image extensions (i.e. .JPG, TIF, .GIF). If the attachment 310a is determined to be a photo or other image, the attachment 310a is passed to a photo conversion process (FIG. 5, step 504; FIG. 3, step 314a). Similarly, if the attachment 310a is determined to be a sound file (step 506), the attachment 310a is passed to a voice conversion process (FIG. 5, step 508; FIG. 3, step 314b). Similarly, if the attachment 310a is determined to be an RFID data file (step 510), the attachment 310a is passed to an RFID conversion process (FIG. 5, step 512; FIG. 3, step 314c). If there is no attachment or if the type of the attachment 310a is unrecognized, the data 310a are passed to a text conversion process (FIG. 5, step 514; FIG. 3, step 314d). Once the attachment and/or data 310a are converted using any of the processes described above, the converted attachment and/or data 316a-d are stored in the user's account in the user database 124.

As mentioned above, the incoming attachments and/or data 310a may be converted to a common format with consistent resolutions, bit rates, and other measures of quality. For example, all TIF, GIF, and BMP image files received as attachments may be converted to a standard 160×120 pixel JPG image through the use of an off-the-shelf image conversion program. For those media formats that have embedded tags or data (e.g., date created), that information may be added to the existing data associated with the attachment. The converted image and the associated data may then be passed to the user database 124 for storage and later processing by the user 102. For each individual capture instance processed, a record in the Capture_Instance table may be created with, for example, the fields shown in Table 1:

TABLE 1

| Field Name | Type | Example |
|---|---|---|
| Capture_ID | Primary Key | C0000001 |
| Username | Foreign Key | JohnDoe |
| Date | | Jan. 01, 2005 |
| Time | | 13:30:00 |
| Media_Type | | Photo, Voice, etc |
| Attachment_Location | | /attachments/xxx.jpg |
| Status | | UnTagged |
| Transmission _Type | | Email, Direct, etc |
| Text | | Bgl and crm chs |

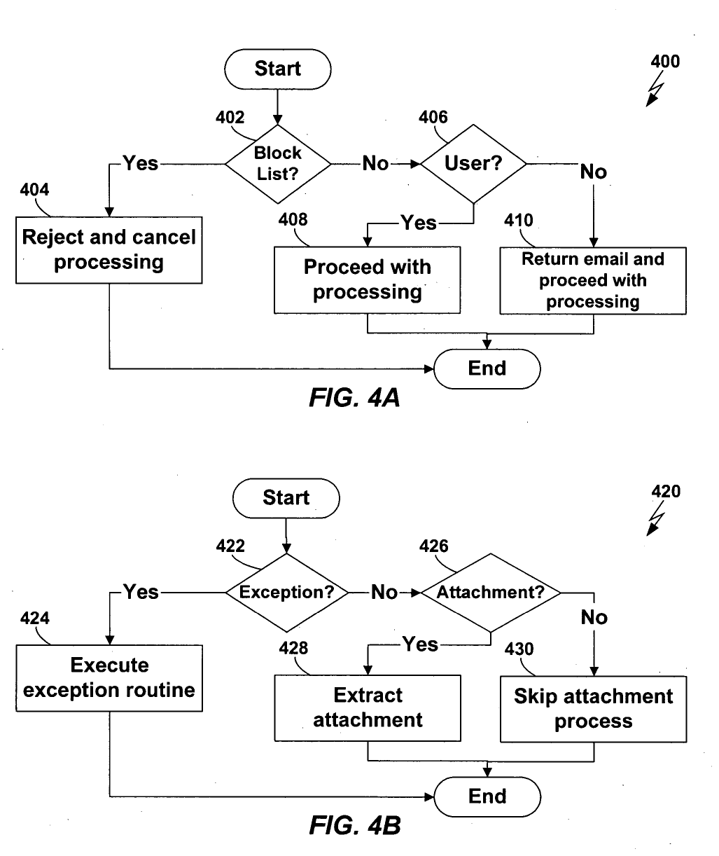

Referring to FIG. 4A, a flowchart is shown of a method 400 that is performed by the capture server 130 in one embodiment of the present invention to filter certain incoming messages from being stored in the user accounts 132a-d. The method 400 may, for example, be performed after step 208 (information receipt) and before step 210 (information storage) in the method 200 shown in FIG. 2A. The method 400 may be used, for example, to block spam or other undesired messages from being stored in the user accounts 132a-d. Although the particular embodiment illustrated in FIG. 4A is applied to email messages, similar techniques may be applied to any kind of incoming communication.

The method 400 compares the “From:” and “To:” fields in the incoming email message to predefined blocked values accessible to the capture server 130 (step 402). The capture server 130 may, for example, maintain a master blocked list and/or a separate blocked list for each of the user accounts 132a-d. If either field matches a blocked value, the server 130 cancels processing, increments a count value in the block list, and deletes the incoming email message (step 404). Note that an “authorized list” may be used in addition to, or instead of, the block list.

If the incoming message is not blocked, the method 400 compares the email alias in the “To:” field to the usernames in the system's central user database 124 (step 406). If the alias matches that of a registered system account, the email message is passed to the next function for processing (step 408). If the alias does not match a registered username, a return email notifying the sender is automatically generated through the outgoing (SMTP) function of the mail server and the email is passed to the next function for processing (step 410).

Certain devices may not transmit messages using a standard attachment format. For example, some cell phone carriers, such as Sprint PCS, transmit photo attachments as an embedded link in an email. Referring to FIG. 4B, a flowchart is shown of a method 420 that may be performed by the capture system 120 to process such non-standard messages using an exception process. The method 420 determines whether an exception is raised by matching the domain of the address in the “From:” line of the incoming email to a predetermined list of domain exceptions accessible to the capture system 120 (step 422). If an exception is matched, the method 420 employs an administrator-defined process to identify and retrieve the embedded photo (step 424). If an exception is not matched, the method 420 determines whether an attachment exists (step 426). If an attachment exists, the method 420 separates the attachment and passes the extracted data and attachment to the next process (step 428). If no attachment exists, the method 420 passes just the extracted data to the next process (step 430).

Note that although certain examples have been described with respect to email messages, the capture system 120 may receive and process incoming communications in any of a variety of formats. For example, as shown in FIG. 3, the capture system 120 may include a direct network connection server 302b for receiving a data stream 304b from the user 102b. If, for example, the health-related item 140 is a weighing scale, the direct network connection server 302b may receive the time, date, and weight registered on the scale. Similarly, the capture system 120 may include a telephone voicemail server 302c for receiving voicemail messages 304c from the user 102. Furthermore, the capture system 120 may include a “push to talk” server 302d for receiving a voice stream 304d from the user 102. In any of these cases, steps 306b-d and 308b-d may be performed in a manner similar to steps 306a and 308a, respectively, as described above. Furthermore, any such incoming communications may be converted to a standard format using steps 314b-d in a manner similar to step 314a, described above.

In general, embodiments of the present invention facilitate the capture and transmission of health-related information for use in tracking such information. For example, embodiments of the present invention enable the user 102 to capture and transmit initial information descriptive of the health-related item 140, such as a digital photograph of a meal, such as by using a digital cellular camera phone to capture and transmit the photograph. The user 102 may perform such information capture and transmission easily and quickly, in as little as a few seconds and with the press of a button. The user 102 need not interrupt his meal, or other health-related activity, to perform additional time-consuming data entry. Embodiments of the present invention therefore enable the user 102 to capture health-related information for use in tracking without significantly interrupting the health-related activity itself. The user 102, therefore, is more likely to use the capture device to capture health-related information and to use the system 100 to perform tracking than other systems which require the user to engage in tedious and time-consuming information-capture tasks.

Furthermore, the widespread adoption and use of mobile devices such as camera phones, digital cameras, and PDAs means that they user 102 may not need to purchase and carry an additional mobile device to obtain the benefits of the system 100. Rather, the user 102 may already own a device such as a camera phone, in which case the user 102 may use his existing camera phone to perform the functions disclosed herein. This may further encourage the user 102 to use the health-related information tracking system 100. Existing camera phones already are equipped with the ability to capture and transmit photos over the Internet. Therefore, the techniques disclosed herein may be implemented using such camera phones without requiring the user 102 to purchase any additional hardware or to learn any additional skills.

Although the system 100 does not require the user 102 to provide detailed health-related information during the performance of the health-related activity, the system 100 does not sacrifice the ability to track detailed health-related information. Rather, the system 100 merely defers the time at which such detailed information is provided until a time that is more convenient to the user 102. As described above with respect to FIGS. 1B and 2B, the user 100 may provide detailed health-related information about the health-related item 140 at some time after providing the initial health-related information 122. For example, the user 102 may wait until returning home from a meal to provide detailed nutritional information about the meal. The system 100 facilitates the provision of such detailed information by automatically storing the initial health-related information 122 in the user's account, thereby facilitating subsequent retrieval of the information by the user 102. For example, the user 102 may access the initial health-related information 122 by using a web browser to log in to the user's account 132a. Upon viewing the initial information 122, the user 102 may provide the additional information 166 to associate with the health-related item 140.

Furthermore, the initial information may contain cues—such as a photograph of the health-related item 140, the time at which information about the health-related item 140 was captured, or the location of the health-related item—to jog the user's memory about the content and context of the health-related item 140, thereby facilitating subsequent entry of additional information about the item 140. In particular, a photograph is more likely to jog the memory of the user 102 than the textual descriptions employed by previous systems. In addition to providing a complete picture of a meal, for example, a photograph may include information about the context of the meal, such as the restaurant in which it was served, thereby providing additional cues to the user 102 about the content of the meal. The generated information 118, such as a datestamp, may further jog the user's memory about the contents of the meal. In addition, the system 100 may provide additional aids to data entry, such as a predetermined database of nutritional information for common food items. In summary, it is easier for the user 102 to provide detailed information at a time of the user's own choosing, rather than during performance of a health-related activity itself. The system 100 facilitates such deferred data entry and decreases the amount of time required to perform such data entry, thereby facilitating and encouraging the use of the nutritional tracking system 100 by the user 102.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

The techniques disclosed herein may be applied to track information related to any kind of health-related item or health-related activity. Other examples include emotions (e.g., happy, depressed), medical history (e.g., blood test results, doctors visits, illness), water/fluid consumption, and prescription medication consumption. Furthermore, the health-related information 122 and 166 is not limited to information related to the health-related item 140, but may also include, for example, information related to the user 102, such as the user's weight, height, or fitness level.

The techniques disclosed herein may be used to track any kind of information related to a health-related item or activity. Examples include quantity, duration, frequency, description, weight, size, manufacturer, source, or history of a health-related item or activity.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising steps of:
(A) receiving, from a user, first information descriptive of a health-related item in the presence of a user of the item; and
(B) queuing the first information for subsequent association with second information descriptive of the health-related item.

2. The method of claim 1, wherein the health-related item comprises a meal to be consumed by the user.

3. The method of claim 1, wherein the health-related item comprises a fitness device to be used by the user.

4. The method of claim 1, wherein the first information comprises information derived automatically from the health-related item.

5. The method of claim 2, wherein the information derived automatically from the health-related item comprises an image of the health-related item.

6. The method of claim 2, wherein the information derived automatically from the health-related item comprises information descriptive of nutritional content of the health-related item.

7. The method of claim 1, wherein the first information comprises information derived from a context of the health-related item.

8. The method of claim 7, wherein the information derived from the context of the health-related item comprises a time at which the information captured automatically was captured.

9. The method of claim 7, wherein the information derived from the context of the health-related item comprises a location of the health-related item.

10. The method of claim 1, wherein the first information comprises information provided by the user.

11. The method of claim 1, wherein the first information comprises a digital photograph of the health-related item.

12. The method of claim 1, wherein the first information comprises information derived from an RFID tag associated with the health-related item.

13. The method of claim 1, wherein the first information comprises a spoken audio stream descriptive of the health-related item.

14. The method of claim 1, wherein the step (A) comprises a step of receiving an email message from the user descriptive of the health-related item.

15. The method of claim 1, wherein the step (A) comprises a step of receiving a voicemail message from the user descriptive of the health-related item.

16. The method of claim 1, wherein the step (A) comprises a step of receiving a message from the user via the World Wide Web.

17. The method of claim 1, wherein the health-related item comprises a meal to be consumed by the user, and wherein the second information comprises information descriptive of nutritional content of the meal.

18. The method of claim 1, further comprising steps of:
(C) at a first location of the user, prior to the step (A), generating the first information; and
(D) at the location of the user, prior to the step (A), transmitting the first information over a first network connection;
wherein the step (A) comprises a step of receiving the first information over the first network connection.

19. The method of claim 18, wherein the step (C) comprises a step of capturing a digital image of the health-related item.

20. The method of claim 18, wherein the step (C) comprises a step of capturing a spoken audio stream descriptive of the health-related item.

21. The method of claim 18, wherein the step (C) comprises a step of scanning an RFID tag associated with the health-related item.

22. The method of claim 18, wherein the first network connection comprises a cellular telephone network connection.

23. The method of claim 1, further comprising a step of:
(C) after the step (B), receiving the second information from the user.

24. The method of claim 23, wherein the second information comprises information descriptive of nutritional content of the health-related item.

25. The method of claim 23, further comprising a step of:
(D) prior to the step (C), at a second location of the user, providing the second information over a second network connection.

26. The method of claim 25, wherein the first and second locations comprises different locations.

27. The method of claim 25, wherein the first and second network connections comprises different network connections.

28. The method of claim 23, further comprising a step of:
(D) prior to the step (C), providing at least some of the first information to the user.

29. The method of claim 1, wherein the step (B) comprises a step of storing the first information in an account associated with the user.

30. A computer-implemented method comprising steps of:
(A) receiving, from a user over a cellular telephone network connection, first information descriptive of a meal in the presence of a user, the first information comprising a digital photograph of the meal; and
(B) queuing the first information for subsequent association with second information descriptive of the meal by storing the first information in an account associated with the user.

31. The method of claim 30, wherein the first information further comprises a time at which the digital photograph was captured.

32. The method of claim 30, wherein the second information comprises information descriptive of nutritional content of the meal, and wherein the method further comprises steps of:
(C) after the step (B), providing at least some of the first information to the user; and
(D) after the step (C), receiving the second information from the user.

33. A system comprising:
reception means for receiving, from a user, first information descriptive of a health-related item in the presence of a user of the item; and
queuing means for queuing the first information for subsequent association with second information descriptive of the health-related item.

34. The system of claim 33, wherein the health-related item comprises a meal to be consumed by the user.

35. The system of claim 33, wherein the health-related item comprises a fitness device to be used by the user.

36. The system of claim 33, wherein the first information comprises information derived automatically from the health-related item.

37. The system of claim 34, wherein the information derived automatically from the health-related item comprises an image of the health-related item.

38. The system of claim 34, wherein the information derived automatically from the health-related item comprises information descriptive of nutritional content of the health-related item.

39. The system of claim 33, wherein the first information comprises information derived from a context of the health-related item.

40. The system of claim 39, wherein the information derived from the context of the health-related item comprises a time at which the information captured automatically was captured.

41. The system of claim 39, wherein the information derived from the context of the health-related item comprises a location of the health-related item.

42. The system of claim 33, wherein the first information comprises information provided by the user.

43. The system of claim 33, wherein the first information comprises a digital photograph of the health-related item.

44. The system of claim 33, wherein the first information comprises information derived from an RFID tag associated with the health-related item.

45. The system of claim 33, wherein the first information comprises a spoken audio stream descriptive of the health-related item.

46. The system of claim 33, wherein the health-related item comprises a meal to be consumed by the user, and wherein the second information comprises information descriptive of nutritional content of the meal.

47. The system of claim 33, further comprising:
means for generating the first information at a first location of the user; and
means for transmitting, at the location of the user, the first information over a first network connection;
wherein the reception means comprises means for receiving the first information over the first network connection.

48. A computer-implemented method comprising steps of:
(A) capturing first information descriptive of a health-related item in the presence of a user of the item; and
(B) transmitting the first information to a system for subsequent association with second information descriptive of the health-related item.

49. The method of claim 48, wherein the health-related item comprises a meal to be consumed by the user.

50. The method of claim 48, wherein the health-related item comprises a fitness device to be used by the user.

51. The method of claim 48, wherein the first information comprises information derived automatically from the health-related item.

52. The method of claim 49, wherein the information derived automatically from the health-related item comprises an image of the health-related item.

53. The method of claim 49, wherein the information derived automatically from the health-related item comprises information descriptive of nutritional content of the health-related item.

54. The method of claim 48, wherein the first information comprises information derived from a context of the health-related item.

55. The method of claim 54, wherein the information derived from the context of the health-related item comprises a time at which the information captured automatically was captured.

56. The method of claim 54, wherein the information derived from the context of the health-related item comprises a location of the health-related item.

57. The method of claim 48, wherein the first information comprises information provided by the user.

58. The method of claim 48, wherein the first information comprises a digital photograph of the health-related item.

59. The method of claim 48, wherein the first information comprises information derived from an RFID tag associated with the health-related item.

60. The method of claim 48, wherein the first information comprises a spoken audio stream descriptive of the health-related item.

61. The method of claim 48, wherein the step (B) comprises a step of transmitting an email message descriptive of the health-related item to the system.

62. The method of claim 48, wherein the step (B) comprises a step of transmitting a voicemail message descriptive of the health-related item to the system.

63. The method of claim 48, wherein the step (B) comprises a step of transmitting a message via the World Wide Web to the system.

64. The method of claim 48, wherein the health-related item comprises a meal to be consumed by the user, and wherein the second information comprises information descriptive of nutritional content of the meal.

65. The method of claim 48, wherein the step (B) comprises a step of transmitting a the first health-related information over a cellular telephone network connection.

66. The method of claim 48, further comprising a step of:
(C) after the step (B), providing the second information to the system over a second network connection.

67. A computer-implemented method comprising steps of:
(A) capturing first information comprising a digital photograph of a meal to be eaten by a user; and
(B) transmitting the first information over a cellular telephone network connection to a system for subsequent association with second information descriptive of the meal.

68. The method of claim 67, wherein the first information further comprises a time at which the digital photograph was captured.

69. The method of claim 67, wherein the second information comprises information descriptive of nutritional content of the meal, and wherein the method further comprises a step of:
(C) transmitting the second information to the system.

70. A system comprising:
capture means for capturing first information descriptive of a health-related item in the presence of a user of the item; and
transmission means for transmitting the first information to a system for subsequent association with second information descriptive of the health-related item.

71. The system of claim 70, wherein the health-related item comprises a meal to be consumed by the user.

72. The system of claim 70, wherein the health-related item comprises a fitness device to be used by the user.

73. The system of claim 70, wherein the first information comprises information derived automatically from the health-related item.

74. The system of claim 71, wherein the information derived automatically from the health-related item comprises an image of the health-related item.

75. The system of claim 71, wherein the information derived automatically from the health-related item comprises information descriptive of nutritional content of the health-related item.

76. The system of claim 70, wherein the first information comprises information derived from a context of the health-related item.

77. The system of claim 76, wherein the information derived from the context of the health-related item comprises a time at which the information captured automatically was captured.

78. The system of claim 76, wherein the information derived from the context of the health-related item comprises a location of the health-related item.

79. The system of claim 70, wherein the first information comprises information provided by the user.

80. The system of claim 70, wherein the first information comprises a digital photograph of the health-related item.

81. The system of claim 70, wherein the first information comprises information derived from an RFID tag associated with the health-related item.

82. The system of claim 70, wherein the first information comprises a spoken audio stream descriptive of the health-related item.

83. The system of claim 70, wherein the health-related item comprises a meal to be consumed by the user, and wherein the second information comprises information descriptive of nutritional content of the meal.

84. The system of claim 70, further comprising:
means for providing the second information to the system over a second network connection.
